(19) United States
(12) Patent Application Publication
(10) Pub. No.: US 2001/0011229 A1
(43) Pub. Date: Aug. 2, 2001

(54) MARKETING RESEARCH SYSTEM AND ASSOCIATED METHODS

(76) Inventors: SCOTT ANDERSON, ORLANDO, FL (US); SHAWN D. LUCAS, SANFORD, FL (US)

Correspondence Address: HENRY ESTEVEZ, ALLEN DYER DOPPELT MILBRATH & GILCHRIST, 255 SOUTH ORANGE AVENUE SUITE 1401, P O BOX 3791, ORLANDO, FL, 328023791

(21) Appl. No.: 09/178,335

(22) Filed: Oct. 23, 1998

(51) Int. Cl. G06F 17/60

(52) U.S. Cl. 705/14; 705/10

(57) ABSTRACT

The present invention discloses a system for marketing research for a consumer visiting a merchant's location to provide responses to queries posed by the merchant and to obtain an immediate incentive award. The system comprises a card having a magnetic strip for containing magnetically encoded information, the card having a detachable data form for recording initial identifying information obtained from the consumer, the card and the data form being correlated by containing the same consumer code; a consumer computer station, or kiosk, comprising a screen, an input device for entering responses to the queries, the input device preferably being a touch-screen, a consumer card scanner for reading and writing the magnetically encoded information on the card and for recording the incentive award after the consumer answers all queries, and programmed to display queries on the screen, and to accept and store the consumer responses in a manner correlated with the consumer code magnetically encoded on the card; a server computer having interactive communication with the consumer computer station, the server being programmed to retrieve the consumer responses from the consumer computer station and to store, manage and analyze the consumer responses in a manner correlated with the consumer code; a merchant computer station comprising a personal computer, monitor and printer, and having interactive communication with the server for inputting and transmitting the initial identifying information to the server in a manner correlated with the consumer code, for retrieving information from the server, and for storing, managing and displaying information retrieved; a merchant card scanner station having interactive communication with the server for reading and writing magnetically encoded information on the card, for verifying and cancelling the award after redemption.

### FIELD OF THE INVENTION

The present invention relates to the field of marketing research and, more specifically, to computer-assisted marketing research conducted on-site at a merchant's location, thereby providing marketing information directly related to the consumers visiting the merchant's store.

### BACKGROUND OF THE INVENTION

Merchants spend millions of dollars every year in advertising their products and services. Merchants conduct advertising through a variety of media calculated to reach potential consumers. One goal of advertising is to deliver the merchant's message to as many potential consumers as possible. The ultimate goal of advertising, however, is to increase sales volume by attracting more consumers to the merchant's store, thereby making it easier for the merchant to induce the consumer to make a purchase.

Most merchants would agree that advertising is an essential ingredient for developing and running a successful business. Many of these same merchants, however, advertise simply because everyone else does, while having no conclusive evidence to show that their advertisements are not only reaching the intended public but also helping increase the merchant's sales volume.

Marketing research is generally conducted through interviews of consumers, sometimes in person, sometimes by telephone. Such research is conducted in an effort to determine whether a merchant's advertising is reaching the targeted public and whether the advertising may be correlated with some impact on sales. Present systems for marketing research, however, are generally surveys in which only a minuscule sample of the merchant's target population is interviewed. It is not unusual, for example, for a marketing research company to survey a handful of consumers in a market area where the population numbers in the thousands, or even hundreds of thousands. Many persons have had the experience of being approached by a marketing surveyor while walking through a shopping area and being asked to fill out a survey questionnaire. It is also not uncommon to receive telephone calls from telemarketers conducting consumer preference surveys, usually in the early evening when people tend to gather at home for dinner. These intrusions are not only annoying to the average person but also produce marketing research whose results are speculative at best and a poor guide for making decisions involving very large amounts of advertising money. Merchants are thus faced with having to make decisions involving millions of advertising dollars while having woefully inadequate marketing research for their target population.

### SUMMARY OF THE INVENTION

In view of the foregoing background, it is therefore an object of the present invention to provide a system for conducting an automated, computer-assisted marketing survey on-site at a merchant's location.

It is a further object of the present invention to provide a merchant with marketing research gathered from the population of potential consumers which visit the merchant's location.

It is yet another object of the present invention to provide a computer-assisted marketing research system which provides the participating consumer an immediate incentive award for responding to the various queries comprising the marketing survey.

It is another object of the present invention to provide a system for the efficient collection and analysis of consumer-related marketing information.

It is still another object of the present invention to provide the merchant with on-demand access to collected marketing research results.

It is a further object of the present invention to provide a system of marketing research which is able to generate consumer traffic to other areas of the merchant's operation.

It is another object of the present invention to provide a merchant with facts gathered during marketing research and related to the merchant's own consumer population.

It is still another object of the present invention to provide the merchant with a system of marketing research which may be easily updated on-line, via an intranet, remotely or on-site at the merchant's location.

### BRIEF DESCRIPTION OF THE DRAWINGS

FIG. 1 is a diagram illustrating the various components of the system for marketing research and the flow of information among them in a preferred embodiment.

FIG. 2 is a flow chart for the system of marketing research illustrating the various decision points in the process and providing a view of the flow of information in a preferred embodiment.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and double prime notation, where used, indicate similar elements in alternative embodiments. Whenever used herein, the term “computer station” is understood to include a personal computer, including the computer with its associated accessories as dictated by the state of the art, for example a keyboard, mouse, monitor and printer. In addition, the term “on-line” indicates access through a secondary connection such as telephone lines to a remote computer or computer network not directly wired to the user's computer, whereas the term “network” includes computers that are directly wired to each other as well as computers linked through such secondary connections.

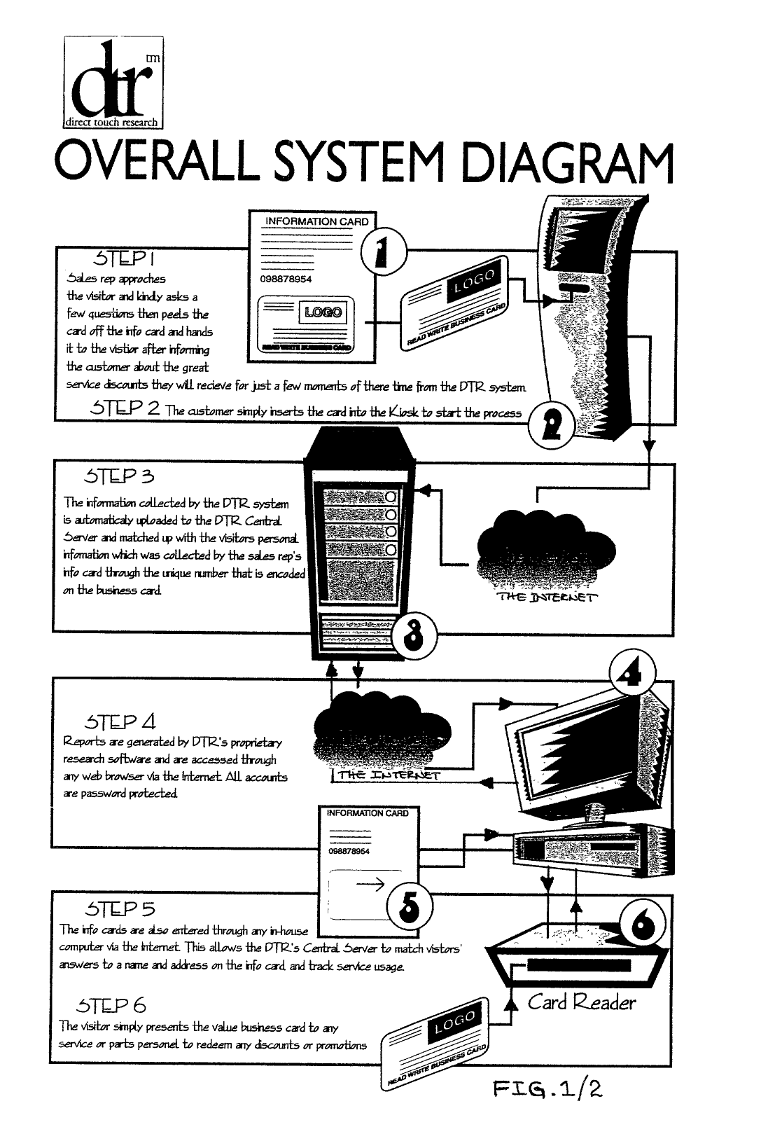

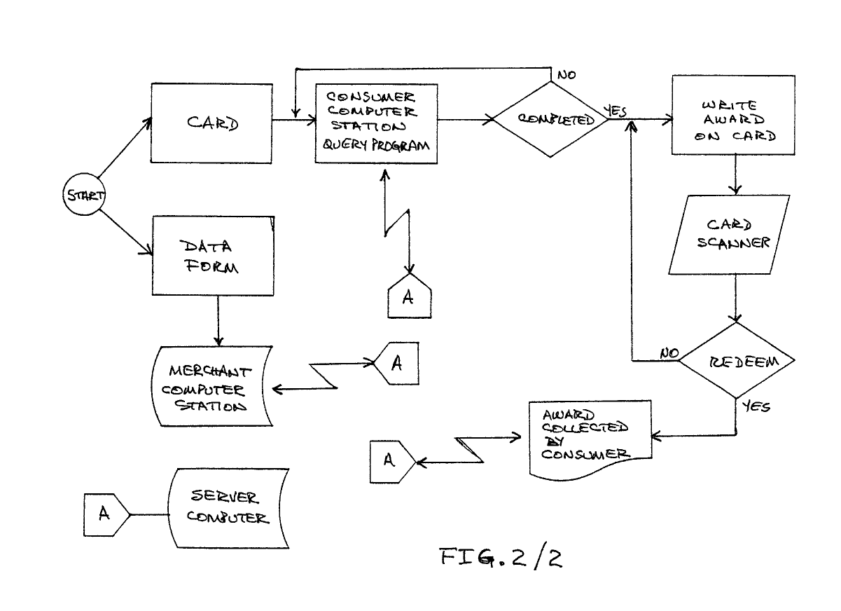

FIGS. 1 and 2 illustrate a preferred embodiment such as might be installed at the location of a merchant who operates an automobile dealership. An automobile dealership has sales people who normally would greet a consumer entering the premises. Upon greeting the consumer, the sales person would offer the consumer the opportunity to receive an incentive award by participating in a short marketing research program and, if the consumer is agreeable, would request some standard information such as first name, last name, address including zip code and telephone number. The sales person would record this initial identifying information on a data form detachable from a card having a magnetic strip for containing magnetically encoded information. The data form and the card share a unique identifier to allow information from the data form and the card to be correlated within the system. The sales person would then detach the card from the data form and give the card to the consumer. In an alternate embodiment, the card includes a computer-readable medium for containing the encoded information.

In order to receive the incentive award the consumer would take the card to a consumer computer station, also called a “kiosk” in the advertising business, which would be located perhaps in the auto showroom, insert the card in the card scanner slot and respond to the queries as they are displayed on the screen. To encourage consumer participation the sequence of queries would be predetermined to allow for completion within a very short time and the input device for the consumer to use would be a touch-screen, avoiding the use of a computer keyboard, which could be intimidating to some consumers. Upon responding to all queries the participating consumer would receive an immediate incentive award. The award would be predetermined by and redeemable through the merchant or, in another embodiment, could be selected by the participating consumer from a menu of awards presented on the screen. The award would be magnetically encoded on the card while in the card scanner and before the card is ejected for retrieval by the participating consumer.

The consumer computer station comprises a screen, a program to display queries on the screen, an input device for recording consumer responses to the queries, a consumer card scanner for reading the information magnetically encoded on the card and for writing magnetically encoded information for recording the incentive award immediately after the consumer answers all queries. The consumer computer station also includes programming software for ensuring that responses are entered for all queries and computer memory for accepting and storing the consumer responses in a manner correlated with the consumer code magnetically encoded on the card. In a preferred embodiment a touch-screen serves as both the screen display and as the input device.

In a preferred embodiment a server computer is linked in interactive communication with the consumer computer station. The server computer is programmed to retrieve the consumer responses from the consumer computer station with a predetermined frequency and to store, manage and analyze the consumer responses in a manner correlated with the consumer code. This process allows for analysis of the collected consumer responses in various ways, according to the merchant's preferences. For example, the collected responses may be sorted and analyzed by zip code area, by telephone exchange, by last name, by gender, in short, by any of the available parameters. The server computer is accessed by the merchant through a password protected account, which also serves as an access point for interaction with the consumer computer station. Access to the server computer may be used to transmit new queries and to provide any other programming to reside in the consumer computer station.

A merchant computer station is also linked in interactive communication with the server computer. The merchant computer station comprises a standard personal computer, including the computer with its associated accessories as dictated by the state of the art, for example a keyboard, mouse, monitor and printer. The merchant computer station is used by the merchant for entering the initial identifying information into the system in a manner correlated with the consumer code, for transmission of the information to the server computer and for retrieving, storing, managing and displaying information from the server computer. Access to the server computer is controlled by password protection, so that the merchant may also be afforded the ability to interact with the consumer computer station by linking through the server computer. The merchant may, in this manner, edit the queries to be presented to the participating consumer.

The participating consumer would redeem the incentive award by presenting the card, now having the award information magnetically encoded thereon, at the merchant's location. For example, an auto dealership might award a free oil and filter change, which the participating consumer would redeem by presenting the card in the dealership's service department, thus also providing the merchant the opportunity of increasing customer traffic to other areas of the business. The merchant would place the card in a magnetic card reader for verification of the award. The magnetic card reader in a preferred embodiment is linked in interactive communication with the server computer for transmitting information related to award redemption and for cancelling the encoded award information on the card thereafter.

The system for marketing research may comprise multiple consumer computer stations or “kiosks” for placement throughout a merchant's establishment and to promote efficient throughput so that participating consumers do not have to wait before beginning the process. Consumer computer stations may be placed throughout a chain of stores, all stations being linked to the server computer for transmission of information. In addition, the system may also comprise multiple merchant computer stations, for example all the computers on a merchant's local area network, even all the computers throughout a merchant's chain of stores. Multiple card scanners may also be included in similar fashion.

The complete system for marketing research may be expressed in other configurations. For example, the system could be encompassed within the computer network in a single location, as within a local area network in a building, or the system may be spread out geographically such that interaction with the server computer is on-line through a global computer network such as the Internet. In yet another embodiment the system for marketing research may be configured for a merchant's location which exists only as an electronic address accessible through a computer network which may be either an intranet or a global network such as the Internet. In this embodiment the consumer computer station would be a consumer's personal computer in communication with the server computer through a connection to the computer network. The consumer computer station, personal computer, would receive the merchant-posed queries from the server computer and the participating consumer would enter the responses to the queries through the personal computer for transmission to the server computer. Upon verification that all queries had received responses, the server computer would generate an electronic certificate for the incentive award. The electronic certificate would be transmitted by the server computer to the consumer computer station, where it could be stored in memory or also printed as a tangible copy. The participating consumer would redeem the incentive award by transmitting the certificate from the consumer's personal computer to the merchant computer station, which could exist solely as an electronic location accessible by on-line communication through a global computer network, for example a web page on the Internet. This embodiment of the system, in effect, provides a method for conducting on-line marketing research through a global computer network and without regard for the physical location of the consumer or the merchant.

In a further embodiment, the system may be abbreviated to its minimum essential component, a computer station programmed to display queries on a screen, to receive, store and analyze responses to the queries, and to issue the respondent consumer an electronic certificate for an incentive award. A printer device may be added to provide a tangible copy of the certificate. This computer station can operate as a stand-alone machine comprising the system for marketing research or, preferably, may be in communication with a computer network including a server computer for providing the queries.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A system for marketing research whereby a consumer visiting a merchant's location provides responses to queries posed by the merchant and obtains an immediate incentive award, said system comprising:
a) a card including a magnetic strip for containing magnetically encoded information including a consumer code, said card having a detachable data form for recording initial identifying information obtained from the consumer, said card and said data form being correlated by containing the same consumer code;
b) a consumer computer station comprising a screen, an input device for recording consumer responses to the queries, a consumer card scanner for reading the information magnetically encoded on said card and for writing magnetically encoded information for recording the incentive award after the consumer answers all queries, and programmed to display queries on the screen, and to accept and store the consumer responses in a manner correlated with the consumer code magnetically encoded on said card;
c) a server computer having interactive communication with said consumer computer station, said server computer programmed to retrieve the consumer responses from said consumer computer station and to store, manage and analyze the consumer responses in a manner correlated with the consumer code;
d) a merchant computer station comprising a personal computer, monitor and printer, and having interactive communication with said server computer for inputting and transmitting the initial identifying information to said server computer in a manner correlated with the consumer code, for retrieving information from said server computer, and for storing, managing and displaying information retrieved from said server computer;
e) a merchant card scanner station having interactive communication with said server computer for reading and writing magnetically encoded information on said card, for the merchant to verify the incentive award for redemption by the consumer and thereafter cancel the magnetically encoded information recording the award.

2. The system of claim 1 wherein said input device is a touch screen.

3. The system of claim 2 wherein said consumer computer station comprises a plurality of stations.

4. The system of claim 3 wherein said merchant computer station comprises a plurality of stations.

5. The system of claim 4 wherein said merchant card scanner station comprises a plurality of stations.

6. The system of claim 4 wherein said merchant card scanner station comprises a plurality of stations.

7. A system for marketing research whereby a consumer visiting a merchant's location provides responses to queries posed by the merchant and obtains an immediate incentive award, said system comprising:
a) a card including a magnetic strip for containing magnetically encoded information including a consumer code, said card having a detachable data form for recording initial identifying information obtained from the consumer, said card and said data form being correlated by containing the same consumer code;
b) a consumer computer station comprising a screen, a program to display queries on the screen, an input device for recording consumer responses to the queries, a consumer card scanner for reading the information magnetically encoded on said card and for writing magnetically encoded information to record the incentive award immediately after the consumer answers all queries, means for accepting and storing the consumer responses in a manner correlated with the consumer code magnetically encoded on said card;
c) a server computer having interactive on-line communication with said consumer computer station, said server computer programmed to retrieve the consumer responses from said consumer computer station and to store, manage and analyze the consumer responses in a manner correlated with the consumer code;
d) a merchant computer station comprising a personal computer, monitor and printer, and having interactive on-line communication with said server computer for inputting and transmitting the initial identifying information to said server computer in a manner correlated with the consumer code, for retrieving information from said server computer, and for storing, managing and displaying information retrieved from said server computer;
e) a merchant card scanner station having interactive on-line communication with said server computer for reading and writing magnetically encoded information on said card, for the merchant to verify the incentive award for redemption by the consumer and thereafter cancel the magnetically encoded information recording the award.

8. The system of claim 7 wherein said input device is a touch screen.

9. The system of claim 8 wherein said consumer computer station comprises a plurality of stations.

10. The system of claim 9 wherein said merchant computer station comprises a plurality of stations.

11. The system of claim 10 wherein said merchant card scanner station comprises a plurality of stations.

12. The system of claim 9 wherein said merchant card scanner station comprises a plurality of stations.

13. A system for marketing research whereby a consumer visiting a merchant's location provides responses to queries posed by the merchant and obtains an immediate incentive award, said system comprising;
a) a consumer computer station having a screen, a program to display queries on the screen and to assign a consumer code to the consumer for correlating the consumer responses with identifying information for the consumer, an input device for entering consumer responses to the queries, means for recording and storing the consumer responses in a manner correlated with the consumer code;
b) a card having a magnetic strip for containing magnetically encoded information written onto said card by a magnetic card printer in communication with and controlled by said consumer computer station, the magnetically encoded information including the consumer code and the incentive award being written onto said card after the consumer has answered all queries, said card being thereafter dispensed to the consumer;
c) a server computer having interactive communication with said consumer computer station, said server computer programmed to retrieve information including consumer responses and consumer codes from said consumer computer station and to store, manage and analyze the consumer responses in a manner correlated with the consumer codes;
d) a merchant computer station having interactive communication with said server computer for retrieving information from said server computer;
e) a merchant card scanner station having interactive communication with said server computer for reading and writing magnetically encoded information on the magnetic strip of said card, for verifying the incentive award upon redemption by the consumer and for thereafter cancelling the magnetically encoded information recording the award.

14. The system of claim 13 wherein said input device is a touch screen.

15. The system of claim 14 wherein said consumer computer station comprises a plurality of stations.

16. The system of claim 15 wherein said merchant computer station comprises a plurality of stations.

17. The system of claim 15 wherein said merchant card scanner station comprises a plurality of stations.

18. The system of claim 15 wherein said merchant card scanner station comprises a plurality of stations.

19. A system for marketing research whereby a consumer visiting a merchant's location provides responses to queries posed by the merchant and obtains an immediate incentive award, said system comprising:
a) a consumer computer station having a screen, a program to display queries on the screen and to assign a consumer code to the consumer for correlating the consumer responses with identifying information for the consumer, an input device for entering consumer responses to the queries, means for recording and storing the consumer responses in a manner correlated with the consumer code;
b) a card having a magnetic strip for containing magnetically encoded information written onto said card by a magnetic card printer in communication with and controlled by said consumer computer station, the magnetically encoded information including the consumer code and the incentive award being written onto said card after the consumer has answered all queries, said card being thereafter dispensed to the consumer;
c) a server computer having interactive on-line communication with said consumer computer station, said server computer programmed to retrieve information including consumer responses and consumer codes from said consumer computer station and to store, manage and analyze the consumer responses in a manner correlated with the consumer codes;
d) a merchant computer station having interactive on-line communication with said server computer for retrieving information from said server computer;
e) a merchant card scanner station having interactive on-line communication with said server computer for reading and writing magnetically encoded information on the magnetic strip of said card, for verifying the incentive award upon redemption by the consumer and for thereafter cancelling the magnetically encoded information recording the award.

20. The system of claim 19 wherein said input device is a touch screen.

21. The system of claim 20 wherein said consumer computer station comprises a plurality stations.

22. The system of claim 21 wherein said merchant computer station comprises a plurality stations.

23. The system of claim 22 wherein said merchant card scanner station comprises a plurality of stations.

24. The system of claim 21 wherein said merchant card scanner station comprises a plurality of stations.

25. A system for marketing research whereby a consumer visiting a merchant's location provides responses to queries posed by the merchant and obtains an immediate incentive award, said system comprising:
a) a consumer computer station having a screen, an input device for entering consumer responses to the queries, a card scanner for writing information onto a computer-readable medium, and a program to display queries on the screen, to assign a consumer code to the consumer for correlating the consumer responses with identifying information for the consumer, and to record and store the consumer responses in a manner correlated with the consumer code;
b) a card for inserting in the card scanner, said card including a computer-readable medium for containing encoded information including the consumer code and the incentive award written onto said card by the card scanner after the consumer has answered all queries, said card being thereafter dispensed to the consumer;
c) a server computer having interactive on-line communication with said consumer computer station, said server computer programmed to retrieve information including consumer responses and consumer codes from said consumer computer station and to store, manage and analyze the consumer responses in a manner correlated with the consumer codes;
d) a merchant computer station having interactive on-line communication with said server computer for retrieving information from said server computer;
e) a merchant card scanner station having interactive on-line communication with said server computer for reading and writing encoded information on said card, for verifying the incentive award upon redemption by the consumer and for thereafter cancelling the encoded information recording the award.

26. The system of claim 25 wherein said input device is a touch screen.

27. The system of claim 26 wherein said consumer computer station comprises a plurality of stations.

28. The system of claim 27 wherein said merchant computer station comprises a plurality of stations.

29. The system of claim 28 wherein said merchant card scanner station comprises a plurality stations.

30. The system of claim 27 wherein said merchant card scanner station comprises a plurality of stations.

31. The system of claim 25 wherein the encoded information on said card is a bar code.

32. The system of claim 31 wherein said input device is a touch screen.

33. The system of claim 32 wherein said consumer computer station comprises a plurality of stations.

34. The system of claim 33 wherein said merchant computer station comprises a plurality of stations.

35. The system of claim 34 wherein said merchant card scanner station comprises a plurality of stations.

36. The system of claim 33 wherein said merchant card scanner station comprises a plurality of stations.

37. A system for marketing research whereby a consumer visiting a merchant's location provides responses to queries posed by the merchant and obtains an immediate incentive award, said system comprising:
a) a computer programmed to display queries on a screen, to assign a consumer code to the consumer for correlating the consumer responses with identifying information for the consumer, to control at least one printer and to store, manage and analyze the consumer responses in a manner correlated with the consumer codes, said computer having an input device for entering consumer responses to the queries;
b) a card including a computer-readable medium containing encoded information written onto said card by a printer in communication with and controlled by said computer, the encoded information including the consumer code and the incentive award being written onto said card immediately after the consumer has answered all queries, said card being thereafter dispensed to the consumer;
c) a card scanner for reading and writing encoded information on said card, for verifying the incentive award upon redemption by the consumer and for thereafter cancelling the encoded information recording the award.

38. The system of claim 37 wherein said card scanner is in interactive communication with said computer.

39. The system of claim 38 wherein said input device is a touch-screen.

40. The system of claim 39 wherein said card includes a magnetic strip and the encoded information is magnetically encoded on said strip.

41. A system for marketing research whereby a consumer visiting a merchants location provides responses to queries posed by the merchant and obtains an immediate incentive award, said system comprising a computer programmed to display on a screen queries to which the consumer provides responses, to assign an electronic consumer code to the consumer for correlating the responses with identifying information for the consumer, to verify that the consumer has responded to all queries, thereafter to electronically generate a certificate redeemable by the consumer for the incentive award and to store, manage and analyze the consumer responses in a manner correlated with the electronic consumer code, said computer having an input device for the consumer to enter responses to the queries.

42. The system of claim 41, wherein the marketing research is accomplished on-site at the merchant's location.

43. The system of claim 42, wherein the input device is a touch-screen.

44. The system of claim 42, wherein said computer is accessed through on-line communication.

45. The system of claim 44, wherein the merchant's location is an electronic location accessible on-line through a computer network.

46. The system of claim 45, further comprising a printer to produce a tangible copy of the certificate.

47. A method for marketing research comprising a series of steps to be performed by a computer and whereby a consumer visiting a merchant's location provides responses to queries posed by the merchant and obtains an immediate incentive award, said method comprising the steps of:
a) electronically displaying queries posed by the merchant;
b) having a participating consumer electronically record responses to the queries;
c) assigning an electronic identifying code to the participating consumer for correlating the responses with information related to the participating consumer;
d) electronically verifying that the participating consumer has responded to all queries;
e) providing the participating consumer with an electronically generated certificate redeemable for a predetermined incentive award;
f) providing electronic storage, management and analysis of the responses in a manner correlated with the electronic identifying code.

48. The method of claim 47, wherein the merchant's location is a physical location and all steps comprising the method are accomplished on-site.

49. The method of claim 48, wherein the method is accomplished through a computer network.

50. The method of claim 49, wherein the method is accomplished through a computer network accessed through on-line communication.

51. The method of claim 47, wherein the merchant's location is an electronic location accessible on-line through a computer network.

52. A method for marketing research whereby a consumer visiting a merchant's location provides responses to queries posed by the merchant and obtains an immediate incentive award, said method comprising the steps of:
a) providing a computer programmed for electronically displaying queries posed by the merchant;
b) having a participating consumer to enter into the computer responses to the queries;
c) having the computer assign an electronic identifying code to the participating consumer for correlating the responses with information related to the participating consumer;
d) having the computer verify that the participating consumer has responded to all queries;
e) having the computer generate for the participating consumer an electronic certificate redeemable for a predetermined incentive award;
f) having the computer to provide electronic storage, management and analysis of the responses in a manner correlated with the electronic identifying code.

53. The method of claim 52, wherein the merchant's location is a physical location and the computer is provided on-site.

54. The method of claim 53, wherein the computer is part of a computer network.

55. The method of claim 52, wherein access to the computer is provided through on-line communication.

56. A method for marketing research comprising a series of steps to be performed by a computer whereby a participating consumer provides responses to queries and obtains an incentive award, said method comprising the steps of:
a) electronically displaying queries and storing responses thereto;
b) providing the participating consumer with a computer-generated certificate redeemable for an incentive award.

57. The method of claim 56, further comprising the step of assigning an identifying code to the participating consumer.

58. The method of claim 57, further comprising the steps of providing electronic storage, management and analysis of the responses in a manner correlated with the identifying code.

59. The method of claim 58, wherein the participating consumer is visiting the merchant's location.

60. The method of claim 59, wherein the merchant's location is a physical location and all steps comprising the method are accomplished on-site.

61. The method of claim 60, wherein the method is accomplished through a computer network.

62. The method of claim 61, wherein the method is accomplished through a computer network accessed through on-line communication.

63. The method of claim 62, wherein the merchant's location is an electronic location accessible on-line through a computer network.
